(19) United States
(12) Patent Application Publication
(10) Pub. No.: US 2004/0215540 A1
(43) Pub. Date: Oct. 28, 2004

(54) System and method for multi-jurisdictional repacking program

(76) Inventor: Olly Buxton, London (GB)

Correspondence Address: GREENBERG TRAURIG, LLP, 885 3RD AVENUE, NEW YORK, NY, 10022, US

(21) Appl. No.: 10/785,330

(22) Filed: Feb. 24, 2004

Related U.S. Application Data
(60) Provisional application No. 60/449,473, filed on Feb. 24, 2003.

(51) Int. Cl. G06F 17/60

(52) U.S. Cl. 705/35

(57) ABSTRACT

Various embodiments of the present invention relate to methods, systems and securities for use in connection with the sale of debt (e.g., notes) issued by a first issuer bound by regulations of a first jurisdiction and the sale of notes issued by a second issuer bound by regulations of a second jurisdiction, wherein the first jurisdiction and the second jurisdiction are distinct from one another.

### CROSS-REFERENCE TO RELATED APPLICATIONS

This application claims the benefit under 35 U.S.C. 119(e) of U.S. Provisional Application Serial No. 60/449,473, filed Feb. 24, 2003.

### FIELD OF THE INVENTION

Various embodiments of the present invention relate to methods, systems and securities for use in connection with the sale of debt (e.g., notes) issued by a first issuer bound by regulations of a first jurisdiction and the sale of notes issued by a second issuer bound by regulations of a second jurisdiction, wherein the first jurisdiction and the second jurisdiction are distinct form one another.

For the purposes of the present application the term “entity” is intended to refer to any person, organization, or group.

Further, for the purposes of the present application the term “security” is intended to refer to an instrument evidencing debt and/or ownership of asset(s).

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, any figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

More particularly, one embodiment of the present invention relates to a method implemented by a programmed computer system for use in connection with the sale of notes issued by a first issuer bound by regulations of a first jurisdiction and the sale of notes issued by a second issuer bound by regulations of a second jurisdiction, wherein the first jurisdiction and the second jurisdiction are distinct from one another, which method comprises the steps of: inputting data regarding the entry by the first issuer into a first multi-jurisdictional program contract with at least one multi-jurisdictional program contract counterparty, wherein each first multi-jurisdictional program contract counterparty is selected from the group including (but not limited to) a trustee, a principal paying agent, a custodian, a paying agent, a transfer agent, an arranger, a calculation agent, a disposal agent, a process agent and a swap counterparty; inputting data regarding the entry by the second issuer into a second multi-jurisdictional program contract with at least one multi-jurisdictional program contract counterparty, wherein each second multi-jurisdictional program contract counterparty is selected from the group including (but not limited to) a trustee, a principal paying agent, a custodian, a paying agent, a transfer agent, an arranger, a calculation agent, a disposal agent, a process agent and a swap counterparty; inputting data regarding the purchase of each note by a noteholder; calculating payments due each noteholder based at least in part upon the input data regarding the purchase of each note; and processing the calculated payments to provide the payments to the noteholders.

In one example (which example is intended to be illustrative and not restrictive), each first multi-jurisdictional program contract counterparty may be the same entity as each corresponding second multi-jurisdictional program contract counterparty.

Of note, the method embodiments described herein may, of course, be implemented using any appropriate computer hardware and/or computer software. In this regard, those of ordinary skill in the art are well versed in the type of computer hardware that may be used (e.g., a mainframe, a mini-computer, a personal computer (“PC”), a network (e.g., an intranet and/or the Internet)), the type of computer programming techniques that may be used (e.g., object oriented programming), and the type of computer programming languages that may be used (e.g., C++, Basic). The aforementioned examples are, of course, illustrative and not restrictive.

Further, while a number of embodiments of the present invention are described herein, it is understood that these embodiments are illustrative only, and not restrictive, and that many modifications may become apparent to those of ordinary skill in the art. For example, certain methods are described herein as being “computer implementable”. In this regard it is noted that while such methods can be implemented using a computer, the methods do not necessarily have to be implemented using a computer. Also, to the extent that such methods are implemented using a computer, not every step must necessarily be implemented using a computer. Further, the various steps may be performed in any desired order. Further still, the invention may be used in the context of one or more issuers, one or more noteholders, one or more trustees, agents, etc. Further still, all dates, interest rates, times, etc. are intended to be illustrative and not restrictive.

In any case, the following disclosure provides a number of examples (which examples are intended to be illustrative and not restrictive) of the present invention:

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method implemented by a programmed computer system for use in connection with the sale of notes issued by a first issuer bound by regulations of a first jurisdiction and the sale of notes issued by a second issuer bound by regulations of a second jurisdiction, wherein the first jurisdiction and the second jurisdiction are distinct from one another, which method comprises the steps of:
inputting data regarding the entry by the first issuer into a first multi-jurisdictional program contract with at least one multi-jurisdictional program contract counterparty, wherein each first multi-jurisdictional program contract counterparty is selected from the group including a trustee, a principal paying agent, a custodian, a paying agent, a transfer agent, an arranger, a calculation agent, a disposal agent, a process agent and a swap counterparty;
inputting data regarding the entry by the second issuer into a second multi-jurisdictional program contract with at least one multi-jurisdictional program contract counterparty, wherein each second multi-jurisdictional program contract counterparty is selected from the group including a trustee, a principal paying agent, a custodian, a paying agent, a transfer agent, an arranger, a calculation agent, a disposal agent, a process agent and a swap counterparty;
inputting data regarding the purchase of each note by a noteholder;
calculating payments due each noteholder based at least in part upon the input data regarding the purchase of each note; and
processing the calculated payments to provide the payments to the noteholders.

2. The method of claim 1, wherein each first multi-jurisdictional program contract counterparty is the same entity as each corresponding second multi-jurisdictional program contract counterparty.
